(19) United States
(12) Patent Application Publication
(10) Pub. No.: US 2026/0167111 A1
(43) Pub. Date: Jun. 18, 2026

(54) ATTACHMENT SYSTEM FOR A VEHICLE ROCKER

(71) Applicant: Scout Motors Inc., Tysons, VA (US)

(72) Inventors: Michael Pennala, Fenton, MI (US); Jeffrey A. Sailor, Commerce Township, MI (US)

(21) Appl. No.: 19/420,289

(22) Filed: Dec. 15, 2025

Related U.S. Application Data
(60) Provisional application No. 63/735,166, filed on Dec. 17, 2024.

(51) Int. Cl. B60R 3/00

(52) U.S. Cl. CPC B60R 3/002

(57) ABSTRACT

A vehicle may include a rocker including a structural sill, and a frame connection coupled to the structural sill, the frame connection defining a frame cleat surface arranged relative to a frame bridge surface by a frame cleat angle of 10 degrees to 50 degrees. A vehicle may include an accessory including an accessory connection defining an accessory cleat surface arranged relative to an accessory bridge surface by an accessory cleat angle of 10 degrees to 50 degrees, wherein the accessory cleat surface is shaped to engage the frame cleat surface.

### CROSS-REFERENCE TO RELATED APPLICATIONS

This application claims the benefit of U.S. Provisional Ser. No. 63/735,166 filed on Dec. 17, 2024, the entire contents of which are incorporated herein by reference.

### BACKGROUND

This disclosure relates to systems for attaching accessories to a rocker of a vehicle. More specifically, this disclosure relates to systems for attaching a running board to a rocker panel of a vehicle.

### SUMMARY

In some aspects, the disclosure relates to a vehicle including: a rocker including a structural sill, and a frame connection coupled to the structural sill, the frame connection defining a frame cleat surface arranged relative to a frame bridge surface by a frame cleat angle of 10 degrees to 50 degrees; and an accessory including an accessory connection defining an accessory cleat surface arranged relative to an accessory bridge surface by an accessory cleat angle of 10 degrees to 50 degrees, wherein the accessory cleat surface is shaped to engage the frame cleat surface.

In some aspects, the disclosure relates to a vehicle, wherein the frame connection and the structural sill are formed as a single aluminum extrusion.

In some aspects, the disclosure relates to a vehicle, wherein the frame connection defines an upright frame wall that is arranged relative to the frame cleat surface by a frame wedge angle of 10 degrees to 55 degrees.

In some aspects, the disclosure relates to a vehicle, wherein the frame connection defines a frame support surface.

In some aspects, the disclosure relates to a vehicle, wherein the frame support surface is arranged relative to the frame bridge surface by a frame support angle of 145 degrees to 205 degrees.

In some aspects, the disclosure relates to a vehicle, wherein the frame connection defines a cleat height between an upper extremity of the frame cleat surface and a lower extremity of the frame support surface of 20 mm to 65 mm.

In some aspects, the disclosure relates to a vehicle, wherein the frame support surface is arranged relative to an upright frame wall by an offset angle of 20 degrees to 40 degrees.

In some aspects, the disclosure relates to a vehicle, wherein the accessory connection defines an accessory arm, and wherein the accessory arm is fastened to the frame support surface.

In some aspects, the disclosure relates to a vehicle, wherein the accessory connection defines an accessory arm surface arranged relative to the frame bridge surface by an accessory support angle of 150 degrees to 175 degrees.

In some aspects, the disclosure relates to a vehicle, wherein the accessory connection defines a bead arranged at a lower extremity of the accessory arm surface.

In some aspects, the disclosure relates to a vehicle, wherein the accessory is a running board.

In some aspects, the disclosure relates to a vehicle, wherein the structural sill is a lower sill of the vehicle, and wherein the rocker includes a rocker facia.

In some aspects, the disclosure relates to a vehicle, wherein the wherein the frame connection includes a plurality of rocker panel brackets.

In some aspects, the disclosure relates to a vehicle, wherein the accessory connection includes a plurality of accessory cleats positioned to engage the rocker panel brackets.

In some aspects, the disclosure relates to a vehicle, wherein one of the plurality of accessory cleats includes a stop plate.

In some aspects, the disclosure relates to an attachment system for a vehicle rocker, the attachment system including: a frame connection configured to be coupled to a lower sill of the vehicle rocker, the frame connection including: an upright frame wall, a frame cleat surface coupled to the upright frame wall, and a frame bridge surface coupled to the frame cleat surface and arranged relative to the frame cleat surface by a frame cleat angle of 10 degrees to 50 degrees ; and a running board including an accessory connection including: a step surface, an accessory cleat surface coupled to the step surface, the accessory cleat surface shaped to engage the frame cleat surface, and an accessory arm surface coupled to the accessory cleat surface and defining an accessory aperture sized to receive the fastener.

In some aspects, the disclosure relates to an attachment system, wherein the running board further includes an accessory bridge surface shaped to engage the frame bridge surface and arranged relative to the accessory cleat surface by an accessory cleat angle of 10 degrees to 50 degrees.

In some aspects, the disclosure relates to an attachment system, wherein the step surface is arranged perpendicular to the upright frame wall.

In some aspects, the disclosure relates to a vehicle rocker including: a lower sill; a frame connection coupled to the lower sill and extending between a front vehicle wheel and a rear vehicle wheel, the frame connection configured to engage an accessory, the frame connection including: a frame cleat surface, and a frame bridge surface coupled to the frame cleat surface and arranged relative to the frame cleat surface by a frame cleat angle of 10 degrees to 50 degrees ; and a facia covering the lower sill.

In some aspects, the disclosure relates to a vehicle rocker, wherein the lower sill is a structural member, and wherein the frame connection includes three rocker panel brackets.

This summary is illustrative only and is not intended to be in any way limiting. Other aspects and advantages of the devices or processes described herein will become apparent in the detailed description set forth herein, taken in conjunction with the accompanying figures, wherein like reference numerals refer to like elements.

### BRIEF DESCRIPTION OF DRAWINGS

The methods, apparatuses, and systems are explained in even greater detail in the following drawings. The drawings are merely exemplary and certain features may be used singularly or in combination with other features. The drawings are not necessarily drawn to scale.

FIG. 1 is a side view of a vehicle, according to some implementations.

FIG. 2 is a side view of another vehicle, according to some implementations.

FIG. 3 is a perspective view of a rocker panel and a running board of the vehicle of FIG. 1, according to some implementations.

FIG. 4 is a perspective view of the running board of FIG. 3, according to some implementations.

FIG. 5 is another perspective view of the running board of FIG. 3, according to some implementations.

FIG. 6 is a perspective view of a rocker panel frame of the rocker panel of FIG. 3, according to some implementations.

FIG. 7 is a front view of the rocker panel of FIG. 3, according to some implementations.

FIG. 8 is a front view of the rocker panel frame of FIG. 6, according to some implementations.

FIG. 9 is a front view of the running board of FIG. 3 connected to the rocker panel frame of FIG. 6, according to some implementations.

FIG. 10 is a perspective view of a rocker panel bracket, according to some implementations.

FIG. 11 is a perspective view of another running board, according to some implementations.

FIG. 12 is another perspective view of the running board of FIG. 11, according to some implementations.

FIG. 13 is a perspective view of the running board of FIG. 11 mounted to three rocker panel brackets of FIG. 10, according to some implementations.

### DETAILED DESCRIPTION

Following below are more detailed descriptions of concepts related to, and implementations of, methods, apparatuses, and systems for attaching accessories (e.g., a running board) to a rocker or rocker panel of a vehicle. The figures illustrate exemplary implementations in detail and the present disclosure is not limited to the details or methodology set forth in the description or illustrated in the figures. The terminology used herein is for the purpose of description only and should not be regarded as limiting.

As utilized herein, the term “rocker” means a panel forming part of bodywork below the level of a passenger door and can include both decorative facia (e.g. molded plastic) and structural sills. The rocker extends between a forward wheel and a rearward wheel of the vehicle.

Referring to the figures generally, the various implementations disclosed herein relate to systems, apparatuses, and methods for attaching an accessory (e.g., a running board) to a rocker (e.g., lower sill) of a vehicle. The rocker includes a rocker cleat that extends along a length of the rocker. The accessory includes an accessory cleat that is shaped to engage the rocker cleat. The engagement of the accessory cleat and the rocker cleat transfers load from the accessory to the frame of the vehicle via the rocker. The rocket cleat can be covered with a facia when the accessory is not attached allowing the vehicle rocker to be customizable. The accessory can be hung from the rocker cleat and only requires a handful of bolts or other fasteners to provide a secure connection.

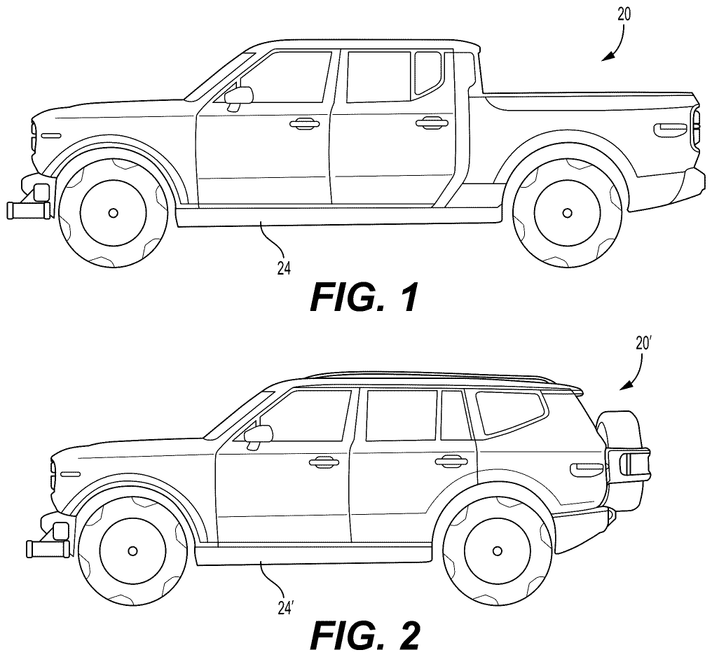

As shown in FIG. 1, a vehicle 20 in the form of a sport utility vehicle includes a rocker 24 (i.e., a rocker panel). As shown in FIG. 2, a vehicle 20′ is the form of a pickup truck includes a rocker 24′ (i.e., a rocker panel). Features discussed below can be implemented on the vehicle 20, the vehicle 20′, or another type of vehicle (e.g., a van) as desired. The following disclosure will reference the rocker 24 of the vehicle 20. It should be understood that the following disclosure is equally applicable to the vehicle 20′ or other vehicles.

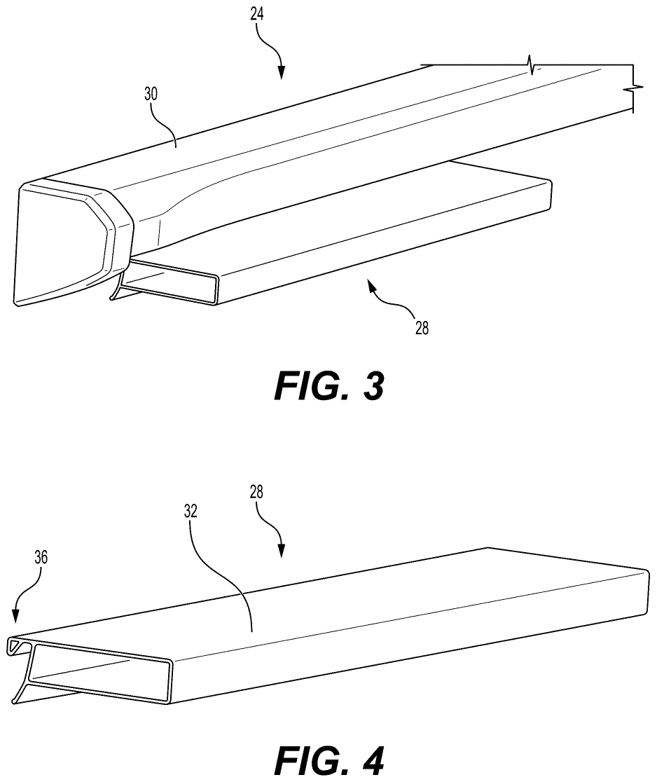

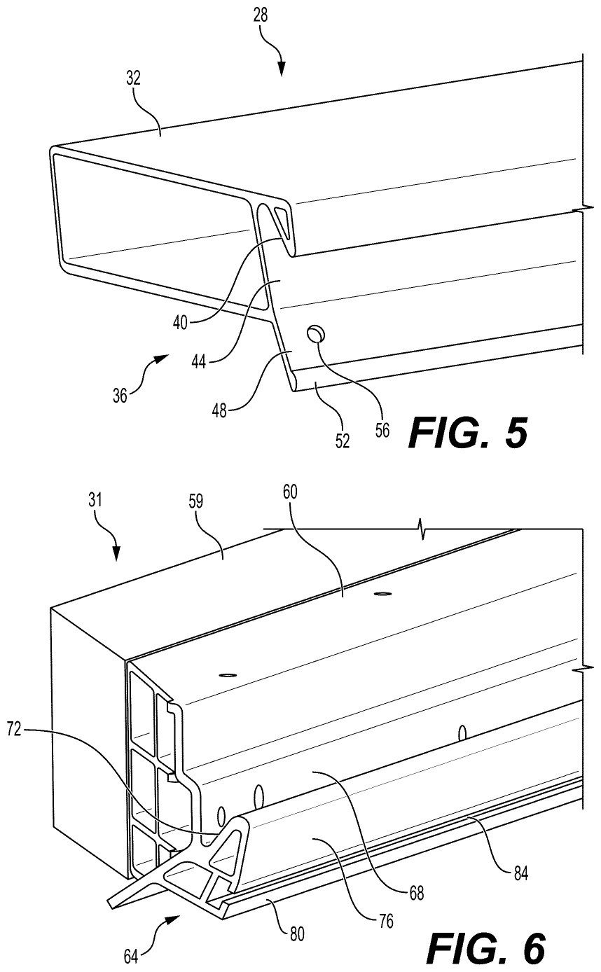

As shown in FIG. 3, an accessory in the form of a running board 28 is connected to the rocker 24. The rocker 24 includes a rocker facia 30 that covers a rocker frame 31 (see FIG. 6). The rocker 24 extends along a length of the vehicle 20 between a front wheel and a rear wheel. In some implementations, the rocker facia 30 is formed of a molded plastic and provides an aesthetic cover for the rocker frame 31. In some implementations, the accessory includes a different component mountable to the rocker 24 (e.g., a water tank, a fuel tank, a storage rack, etc.).

As shown in FIG. 4, the running board 28 includes a step surface 32, and an accessory connection 36 shaped to engage the rocker frame 31 and support the step surface 32 during use. In some implementations, the running board 28 is formed of an extruded aluminum. In some implementations, the running board 28 is formed of a composite material. In some implementations, the accessory connection 36 is formed of an extruded aluminum and the running board 28 includes other materials (e.g., wood, plastic, composite, steel, etc.).

As shown in FIG. 5, the accessory connection 36 includes an accessory cleat surface 40, an accessory bridge surface 44, and an accessory arm surface 48. In some implementations, the accessory arm surface 48 defines a bead 52 extending along a length of the accessory arm surface 48 and raised relative to the accessory arm surface 48. In some implementations, the bead 52 is semi circular shaped. In some implementations, the bead 52 is triangular, square, or has another cross-sectional shape. An accessory aperture 56 is formed in the accessory arm surface 48. In some implementations, the accessory aperture 56 is a round through-hole. In some implementations, the accessory aperture 56 is an elongated slot. In some implementations, the accessory arm surface 48 defines several accessory apertures 56 spaced apart along a length of the accessory arm surface 48.

As shown in FIG. 6, the rocker frame 31 includes a frame member 59 and a structural sill 60 (e.g., a lower sill beam). The structural sill 60 includes a frame connection 64 that extends along a length of the structural sill 60. The frame connection 64 is shaped to engage the accessory connection 36 of the running board 28. The frame connection 64 includes an upright frame wall 68, a frame cleat surface 72, a frame bridge surface 76, a frame support surface 80, and a frame coupling structure in the form of a t-slot 84 positioned in the frame support surface 80. In some implementations, the frame connection 64 is formed integrally with the structural sill 60. In some implementations, the frame member 59 is a steel frame beam. In some implementations, the structural sill 60 is formed as an aluminum extrusion. In some implementations, the frame connection 64 is formed as an aluminum extrusion and is fastened to the structural sill 60 or the frame member 59.

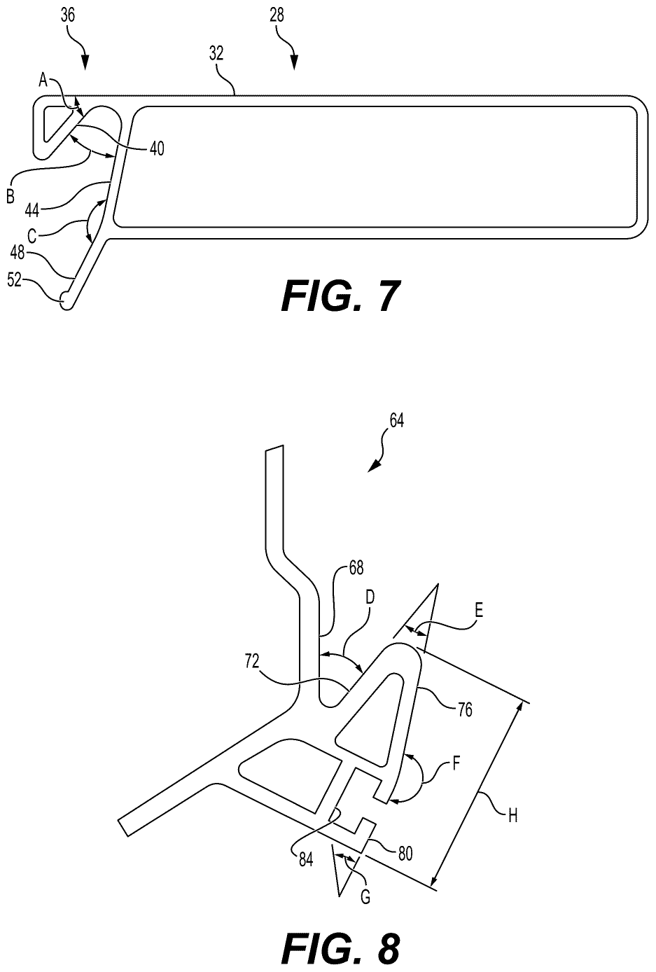

As shown in FIG. 7, the accessory cleat surface 40 of the accessory connection 36 is arranged at an accessory wedge angle A relative to the step surface 32. In some implementations, the wedge angle A is 50 degrees. In some implementations, the accessory wedge angle A is 35 degrees to 80 degrees. The accessory bridge surface 44 is arranged at an accessory cleat angle B from the accessory cleat surface 40. In some implementations the accessory cleat angle B is 29 degrees. In some implementations, the accessory cleat angle B is 10 degrees to 50 degrees. The accessory arm surface 48 is arranged at an accessory support angle C from the accessory bridge surface 44. In some implementations, the accessory support angle C is 165 degrees. In some implementations, the accessory support angle C is 150 degrees to 175 degrees.

As shown in FIG. 8, the upright frame wall 68 of the frame connection 64 is arranged at a frame wedge angle D relative to the frame cleat surface 72. In some implementations, the frame wedge angle D is 40 degrees. In some implementations, the frame wedge angle D is 10 degrees to 55 degrees. In some implementations, the upright frame wall 68 is vertical relative to a ground plane. The frame cleat surface 72 is arranged at a frame cleat angle E relative to the frame bridge surface 76. In some implementations, the frame cleat angle E is 27 degrees. In some implementations, the frame cleat angle E is 10 degrees to 50 degrees. The frame bridge surface 76 is arranged at a frame support angle F relative to the frame support surface 80. In some implementations, the frame support angle F is 195 degrees. In some implementations, the frame support angle F is 145 degrees to 205 degrees. The frame support surface 80 is arranged at an offset angle G relative to the upright frame wall 68. In some implementations, the offset angle G is 27 degrees. In some implementations, the offset angle G is 20 degrees to 40 degrees. The frame connection 64 also defines a cleat height H between an upper extremity of the frame cleat surface 72 and a lower extremity of the frame support surface 80. In some implementations, the cleat height H is 55 mm. In some implementations, the cleat height H is 20 mm to 65 mm.

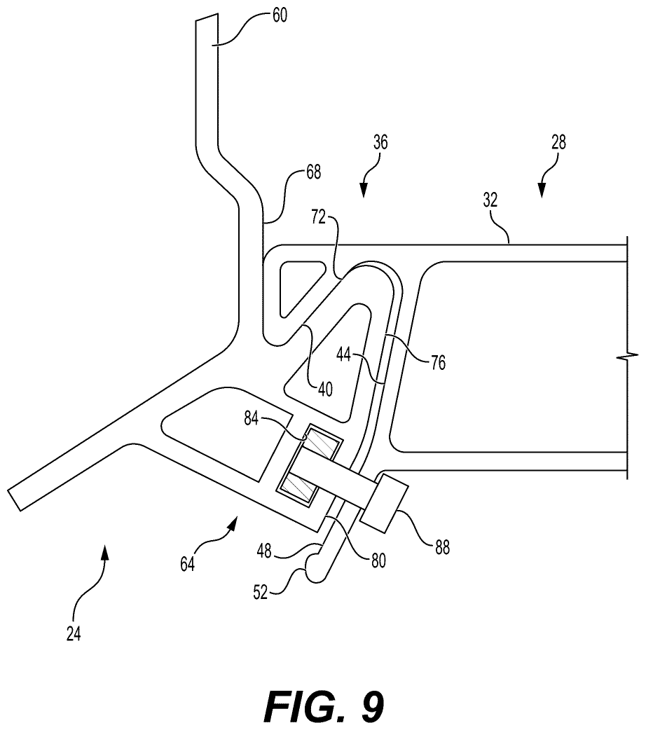

As shown in FIG. 9, the accessory connection 36 of the running board 28 engages the frame connection 64 of the rocker 24. A fastener 88 is engaged through the accessory aperture 56 and into the t-slot 84 to maintain the accessory arm surface 48 in engagement with the frame support surface 80 and therefore the accessory connection 36 engaged with the frame connection 64 so that load is transferred from the accessory cleat surface 40 to the frame cleat surface 72. In some implementations, the fastener 88 is a bolt and t-slot fastener. In some implementations, the bead 52 is positioned on the accessory arm surface 48 to extend beyond the bottom extremity of the frame support surface 80 so that it can aid in assembly and maintaining the accessory connection 36 in engagement with the frame connection 64.

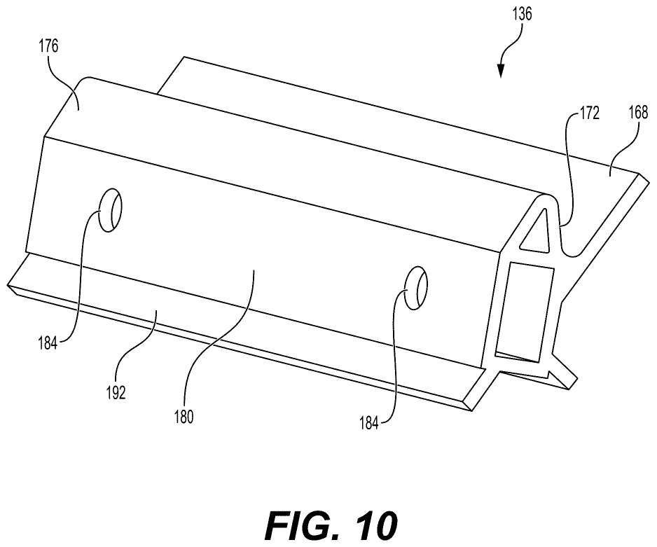

As shown in FIG. 10, a rocker panel bracket 136 can be attached to the rocker frame 31 or the structural sill 60 if no frame connection 64 is present or built into the structural sill 60. The rocker panel bracket 136 includes an upright frame wall 168, a frame cleat surface 172, a frame bridge surface 176, a frame support surface 180, fastener apertures 184, and a lower wall 192. In some implementations, the rocker panel bracket 136 is welded to the structural sill 60 or the rocker frame 31. In some implementations, the rocker panel bracket 136 is fastened to the structural sill 60 or the rocker frame 31. Portions of the rocker panel bracket 136 are similar to the described portions of the accessory connection 36 discussed above and are similarly numbered in the 100 series of reference numbers.

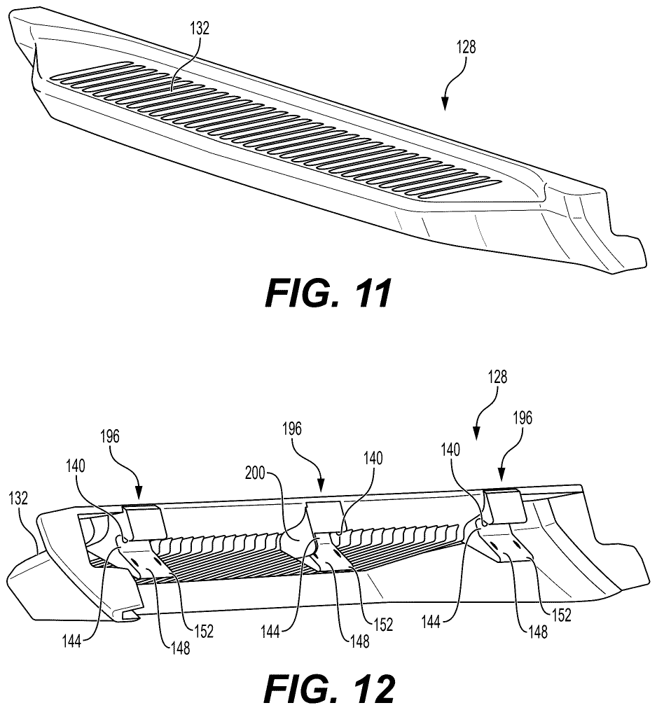

As shown in FIG. 11, a running board 128 includes a step surface 132. The running board 128 is similar to the step surface 32 discussed above and similar features are similarly numbered in the 100 series of reference numbers.

As shown in FIG. 12, the running board 128 includes three accessory cleats 196 spaced apart from one another. In some implementations, more than three or less than three accessory cleats 196 are included. Each accessory cleat 196 includes an accessory cleat surface 140, an accessory bridge surface 144, an accessory arm surface 148, and a bead 152. In some implementations, the bead 152 is eliminated. In some implementations, the bead 152 is shaped to engage the lower wall 192 of the rocker panel brackets 136 and increase the rigidity of the connection. Each accessory cleat 196 is shaped to engage one of the rocker panel brackets 136 discussed above and be fastened thereto using fasteners 88. One or more of the accessory cleats 196 includes a stop plate 200.

The rocker panel brackets 136 are attached to the rocker frame 31 or the structural sill 60 at a predetermined spacing, and the accessory cleats 196 are positioned at the predetermined spacing so that they align with and engage the rocker panel brackets 136.

While the ranges of angles and lengths of the various faces of the accessory connection 36 and the running board 28 discussed above are still applicable to the running board 128 and the rocker panel brackets 136, some exemplary values are given hereafter for the faces and lengths of the running board 128 and the rocker panel brackets 136. In some implementations, the wedge angle A of each accessory cleat 196 is 39 degrees. In some implementations the accessory cleat angle B is 45 degrees. In some implementations, the accessory support angle C is 153 degrees. In some implementations, the frame wedge angle D is 48 degrees. In some implementations, the frame cleat angle E is 45 degrees. In some implementations, the frame support angle F is 153 degrees. In some implementations, the offset angle G is 30 degrees. In some implementations, the cleat height H is 27 mm.

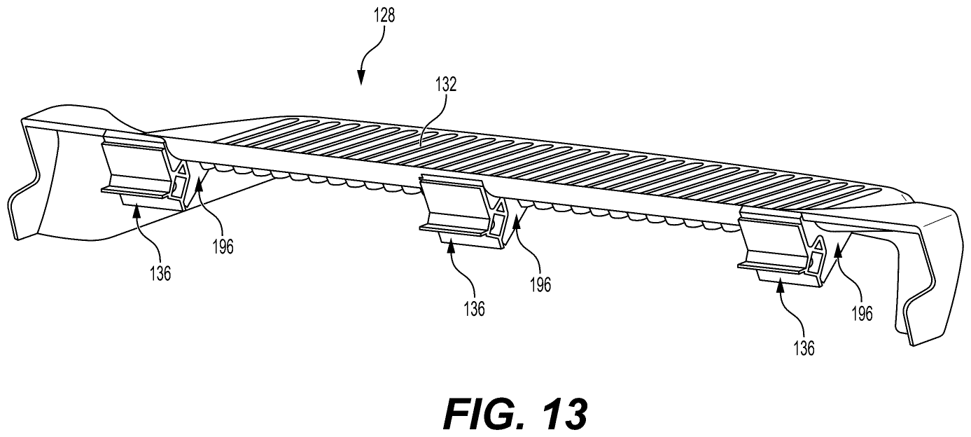

As shown in FIG. 13, in operation, the running board 128 can be installed easily by engaging the three accessory cleats 196 with the rocker panel brackets 136 even if they are not well aligned. The running board 128 is then pushed or translated until the stop plate 200 comes into engagement or abutment with the corresponding rocker panel bracket 136 and the running board 128 is then aligned correctly with the rocker panel brackets 136 and the fasteners 88 can be installed to connect the running board 128.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A vehicle comprising:
a rocker including
a structural sill, and
a frame connection coupled to the structural sill, the frame connection defining a frame cleat surface arranged relative to a frame bridge surface by a frame cleat angle of 10 degrees to 50 degrees; and
an accessory including an accessory connection defining an accessory cleat surface arranged relative to an accessory bridge surface by an accessory cleat angle of 10 degrees to 50 degrees,
wherein the accessory cleat surface is shaped to engage the frame cleat surface.

2. The vehicle of claim 1, wherein the frame connection and the structural sill are formed as a single aluminum extrusion.

3. The vehicle of claim 1, wherein the frame connection defines an upright frame wall that is arranged relative to the frame cleat surface by a frame wedge angle of 10 degrees to 55 degrees.

4. The vehicle of claim 1, wherein the frame connection defines a frame support surface.

5. The vehicle of claim 4, wherein the frame support surface is arranged relative to the frame bridge surface by a frame support angle of 145 degrees to 205 degrees.

6. The vehicle of claim 4, wherein the frame connection defines a cleat height between an upper extremity of the frame cleat surface and a lower extremity of the frame support surface of 20 mm to 65 mm.

7. The vehicle of claim 4, wherein the frame support surface is arranged relative to an upright frame wall by an offset angle of 20 degrees to 40 degrees.

8. The vehicle of claim 4, wherein the accessory connection defines an accessory arm, and wherein the accessory arm is fastened to the frame support surface.

9. The vehicle of claim 1, wherein the accessory connection defines an accessory arm surface arranged relative to the frame bridge surface by an accessory support angle of 150 degrees to 175 degrees.

10. The vehicle of claim 9, wherein the accessory connection defines a bead arranged at a lower extremity of the accessory arm surface.

11. The vehicle of claim 1, wherein the accessory is a running board.

12. The vehicle of claim 1, wherein the structural sill is a lower sill of the vehicle, and wherein the rocker includes a rocker facia.

13. The vehicle of claim 1, wherein the wherein the frame connection includes a plurality of rocker panel brackets.

14. The vehicle of claim 13, wherein the accessory connection includes a plurality of accessory cleats positioned to engage the rocker panel brackets.

15. The vehicle of claim 14, wherein one of the plurality of accessory cleats includes a stop plate.

16. An attachment system for a vehicle rocker, the attachment system comprising:
a frame connection configured to be coupled to a lower sill of the vehicle rocker, the frame connection including:
an upright frame wall,
a frame cleat surface coupled to the upright frame wall, and
a frame bridge surface coupled to the frame cleat surface and arranged relative to the frame cleat surface by a frame cleat angle of 10 degrees to 50 degrees; and
a running board including an accessory connection including:
a step surface,
an accessory cleat surface coupled to the step surface, the accessory cleat surface shaped to engage the frame cleat surface, and
an accessory arm surface coupled to the accessory cleat surface and defining an accessory aperture sized to receive the fastener.

17. The attachment system of claim 16, wherein the running board further includes an accessory bridge surface shaped to engage the frame bridge surface and arranged relative to the accessory cleat surface by an accessory cleat angle of 10 degrees to 50 degrees.

18. The attachment system of claim 16, wherein the step surface is arranged perpendicular to the upright frame wall.

19. A vehicle rocker comprising:
a lower sill;
a frame connection coupled to the lower sill and extending between a front vehicle wheel and a rear vehicle wheel, the frame connection configured to engage an accessory, the frame connection including:
a frame cleat surface, and
a frame bridge surface coupled to the frame cleat surface and arranged relative to the frame cleat surface by a frame cleat angle of 10 degrees to 50 degrees; and
a facia covering the lower sill.

20. The vehicle rocker of claim 19, wherein the lower sill is a structural member, and wherein the frame connection includes three rocker panel brackets.
